(19) United States
(12) Patent Application Publication
(10) Pub. No.: US 2003/0009652 A1
(43) Pub. Date: Jan. 9, 2003

(54) Data processing system and control method

(76) Inventor: Takeshi Satou, Tokyo (JP)

Correspondence Address: William C. Rowland, BURNS, DOANE, SWECKER & MATHIS, L.L.P., P.O. Box 1404, Alexandria, VA, 22313-1404, US

(21) Appl. No.: 10/171,750

(22) Filed: Jun. 17, 2002

(30) Foreign Application Priority Data
Jun. 25, 2001 (JP) 2001-191346

(51) Int. Cl. G06F 15/00

(52) U.S. Cl. 712/34; 712/226

(57) ABSTRACT

A VUPU processor that is equipped with a special-purpose processing unit VU and a general-purpose processing unit PU is highly flexible and executes processing at high speed. In addition, in this invention, cooperative instructions that specify cooperative processing by the VU and the PU are introduced. When a fetched instruction is a cooperative instruction, the decode stage instruction is supplied to the VU and PU. The cooperative instruction can make the resources of the PU available to the VU, so that the resources of the PU can be used by the VU with effectively no overheads being required by the transfer of data between the VU and PU, so that an extremely flexible, high-speed processor is achieved.

### BACKGROUND OF THE INVENTION

1. Technical Field

The present invention relates to a data processing system that is equipped with dedicated circuit.

2. Description of the Related Art

There have been increasing demands for processors that are dedicated to particular applications. In the fields of image processing and network processing, for example, a processor equipping with dedicated circuit that is dedicated to certain processes and special-purpose or dedicated instructions for activating such dedicated circuit flexibly handles the specifications of different applications and is produced with superior cost-performance. The applicant of the present application discloses of such processor in U.S. Pat. No. 6,301,650.

One difficulty when producing a processor that can flexibly handle the specifications of applications according to the user's desired specification is that there is a trade-off between (i) the freedom with which special-purpose instructions (user specified instructions) can be implemented in accordance with user demands and (ii) the ability to execute such special-purpose instructions with low overheads.

The processor disclosed in U.S. Pat. No. 6,301,650 is equipped with one or more special-purpose unit (a special-purpose data processing unit, hereafter referred to as the “VU”) and a general-purpose unit (a basic execution unit or processor unit, hereafter referred to as the “PU”) that can perform general-purpose processing or basic processing. The processor has, in addition to the general-purpose processing ability supplied by the general-purpose processing unit PU, special-purpose processing ability supplied by dedicated circuit, which is dedicated to processing for performing the user's desired specification and such dedicated circuit can be implemented with an extremely high degree of freedom. Therefore, special-purpose instructions defined by the user can be implemented with an extremely high degree of freedom. In the processor, equipping with registers that are commonly accessed by both the PU and VUs, data transfers between the PU and VUs can be performed by merely executing a register transfer instruction such as a “MOVE” instruction. In this way, the processor has an architecture in which special-purpose instructions, including instructions that exchange data with the PU, can be implemented as VUs with great freedom.

In the fields of image processing and network processing where real-time processing is required, there have been increasing demands in recent years for high-speed processing and real-time processing at a higher processing level. For example, in the above processor that transfers data via registers, when a VU performs data processing on PU data according to a user special-purpose instruction, at least two cycles are required by processing that first transfers the data from the PU and transfers the computation result back from the VU. If the processing performed by the VU consumes a large number of clocks, such as several dozen clocks, the number of clocks consumed by the data transfers between the VU and the PU is relatively low compared to the number of cycles consumed by the processing by the VU, and so is not particularly significant. However, if processing performed by the VU is based on a product-sum operation and is completed in a few clocks, the number of clocks consumed by the data transfers appears as an extremely large overhead.

In particular, when the range of processing that can be executed by special-purpose instructions that are implemented using dedicated circuitry of VU is increased in order to raise the processing speed of the processor, the number of clocks consumed by the processing of each dedicated circuit tends to fall, resulting in a relative increase in the overheads of data transfers.

A method where a common register is equipped with for commonly accessed by a PU and a VU has a wide applicability. However, at least one cycle is consumed when transferring data from an internal register of the PU or VU to the common register used for data transfer, so that a total of four cycles are consumed when data is transferred between the VU and PU and is sent back thereafter. As explained, large improvements in processing speed are expected by reducing the number of clocks consumed by data transfers. However, modifying the configuration of the PU to suit the configuration of the VU sacrifices the general-purpose nature of the PU, thereby reducing the value of the PU as a platform on which a VU of a desired configuration can be implemented in accordance with a user specification. If it becomes necessary to redesign the PU as well, the development period of the processor becomes longer and the cost of the processor increases, so that this is not an economical solution.

The present invention has a first object of providing a data processing apparatus or system and a control method thereof that can reduce the overheads of data transfers between PU and VU without sacrificing the general-purpose nature of the PU. A second object of the present invention is to provide a data processing system and a control method in which processing can be executed by VU without no or little apparent consumption of clock cycles due to data transfers between VU and PU.

### SUMMARY OF THE INVENTION

According to the present invention, cooperative instructions that specify cooperative processing to be performed by both a special-purpose processing unit and a general-purpose processing unit are provided in addition to special-purpose instructions that specify processing to be performed by the special-purpose processing unit and general-purpose instructions that specify processing to be performed by the general-purpose processing unit. A data processing system provided by the invention comprising: a special-purpose processing unit that includes dedicated circuitry that is suited to special data processing; a general-purpose processing unit that is suited to general-purpose data processing; and a fetch unit for supplying an instruction fetched from a code memory or a decoded instruction to the special-purpose processing unit and/or the general-purpose processing unit. The fetch unit supplies, when the instruction fetched from the code memory is a special-purpose instruction that specifies processing to be performed by the special-purpose processing unit, the special-purpose instruction or a decoded instruction produced by decoding the special-purpose instruction to the special-purpose processing unit. The fetch unit also supplies, when the fetched instruction is a general-purpose instruction that specifies processing to be performed by the general-purpose processing unit, the general-purpose instruction or a decoded instruction produced by decoding the general-purpose instruction to the general-purpose processing unit. The fetch unit further supplies, when the fetched instruction is a cooperative instruction that specifies cooperative processing by the special-purpose processing unit and the general-purpose processing unit, the cooperative instruction or a decoded instruction produced by decoding the cooperative instruction to the special-purpose processing unit and the general-purpose processing unit.

The present invention also provides a method of controlling the data processing system, including steps of: fetching an instruction code from the code memory; supplying, when the fetched instruction code is the special-purpose instruction, the special-purpose instruction or the decoded instruction thereof to the special-purpose processing unit; supplying, when the fetched instruction code is the general-purpose instruction, the general-purpose instruction or the decoded instruction thereof to the general-purpose processing unit; and supplying, when the fetched instruction is the cooperative instruction, the cooperative instruction or the decode instruction thereof to the special-purpose processing unit and the general-purpose processing unit.

For the above data processing apparatus or control method, a program or program product including special-purpose instructions, general-purpose instructions and cooperative instructions is provided by recording onto a suitable recording medium, such as a code ROM or RAM. With the present data processing apparatus and control method, the fetch unit or fetch step fetches, from a program including special-purpose instructions, general-purpose instructions and cooperative instructions, one or some instructions in the order arranged (the arrangement includes branches and jumps), and supplies the instructions to a special-purpose processing unit and/or a general-purpose processing unit. Accordingly, at the program level, it is possible to perform cooperative control over the order of the processing in the special-purpose processing unit and the general-purpose processing unit. This means that even if there is no special circuit for synchronizing the two different kinds of units, control can be performed over the processing of the special-purpose processing unit and the general-purpose processing unit, including control over parallel processing.

In a data processing apparatus that includes a plurality of special-purpose processing units, control can be performed at the program level over the processing, including parallel processing by the plurality of special-purpose processing units including the general-purpose processing unit. By providing cooperative instructions that specify processing in the special-purpose processing unit and the general-purpose processing unit acting in parallel, in common and/or in associated with, and supplies the cooperative instructions to the both special-purpose processing unit and the general-purpose processing unit, cooperative processing can be executed with the general-purpose processing unit and the special-purpose processing unit in synchronization. In such a cooperative processing, a processing can be executed using a data path composed of some or all of the hardware resources of the general-purpose processing unit and some or all of the hardware resources of the special-purpose processing unit.

By the cooperative processing, a process conventionally performed after transferring data from the general-purpose processing unit to the special-purpose processing unit via a shared register, can be performed by a data path composed of resources of the general-purpose processing unit, such as internal registers, and resources of the special-purpose processing unit, such as a computing unit, without transferring data via shared register or the like. It is also possible to return the result of the processing to the general-purpose processing unit without transferring data via shared register or the like.

As one example, processing, in which data stored in internal registers of the general-purpose processing unit is processed by the dedicated circuitry of the special-purpose processing unit and the result is stored back in the internal registers of the general-purpose processing unit, can be executed using the same number of cycles (except for delays caused when flip-flops or the like are involved) as when the same processing is performed for data that is already present in the special-purpose processing unit. A reduction is made in the number of clocks consumed by data transfers, and commands for data transfers and the like are no longer necessary, so that cycles that are consumed by data transfers can be prevented from appearing in the program.

Cooperative instructions are required depending on the specification of the application that is to be realized by a data processing apparatus. However, if cooperative instructions are implemented by the basic architecture or control commands of general-purpose processing unit, the effect of the present invention can be achieved without sacrificing general-purpose nature of general-purpose processing unit used as platform for implementing special-purpose processing unit that is developed or designed in accordance with a specification.

In the present invention, at the program level, it is possible to perform processing where the special-purpose processing unit or the general-purpose processing unit uses the hardware resources of the other by the cooperative instruction. The special-purpose processing unit usually including dedicated circuitry that differs depending on the specification to be implemented. From the viewpoint of general-purpose instructions that specify the processing of the general-purpose processing unit, no great advantage may be gained by defining cooperative instructions as one of the general-purpose instruction that use some of the resources of the special-purpose processing unit.

On the other hand, the hardware resources that are provided as the general-purpose processing unit are normally available for use. From the viewpoint of special-purpose instructions that specify the processing of the special-purpose processing unit, while defining cooperative instructions that can use some or all of the resources of the general-purpose processing unit results in the parallelism of the general-purpose processing and the special-purpose processing being sacrificed, it enables the resources of the general-purpose processing unit to be used as part of the dedicated circuitry. Accordingly, it becomes possible to omit redundant hardware resources, so that the special-purpose processing unit can be made compact.

Since the basic circuit components of the general-purpose processing unit can be easily used as part of the dedicated circuitry, freedom of special-purpose instructions increase. Also, it is no longer necessary to perform data transfers between the general-purpose processing unit and the special-purpose processing unit as separate processes, so that the overheads caused by data transfers become less.

According to the present invention, a processor or data processing system will be provided that can flexibly handle a specification of an application in response to user demands and can implement special-purpose instructions (user specified instructions) as instructions executing either with no overheads or with no apparent overheads.

Instructions that make at least some of the hardware resources of the general-purpose processing unit available to the special-purpose processing unit are effective as the cooperative instructions, and are suited to the low-cost provision of a processor with high-speed processing that is suited to real-time processing. Examples of such cooperative instructions are as follows. A general-purpose register access instruction is an instruction that has the special-purpose processing unit execute processing with data in the general-purpose register or registers of the general-purpose processing unit as input. A general-purpose computing unit access instruction is an instruction that has the computing unit of the general-purpose processing unit execute processing with data in the special-purpose register or registers of the special-purpose processing unit as input. A general-purpose RAM write instruction is an instruction that writes data present in the special-purpose registers of the special-purpose processing unit into a data RAM of the general-purpose processing unit. A general-purpose RAM read instruction is an instruction that writes data present in a data RAM of the general-purpose processing unit into the special-purpose registers of the special-purpose processing unit.

To handle the general-purpose register access instruction, the general-purpose processing unit is preferably provided with a data path that outputs data present in the general-purpose registers indicated or designated by the general-purpose register access instruction to the special-purpose processing unit, and a data path that writes data which has been processed by the special-purpose processing unit into the general-purpose register indicated by the general-purpose register access instruction. The general-purpose register access instruction can be handled without sacrificing the general-purpose nature of the general-purpose processing unit.

To handle the general-purpose computing unit access instruction, the general-purpose processing unit is preferably provided with a data path for supplying data from the special-purpose data processing unit for performing the processing designated by the general-purpose computing unit access instruction in the computing unit and outputting a result to the special-purpose processing unit. To handle the general-purpose RAM write instruction, the general-purpose processing unit is preferably provided with a data path for obtaining an address in the data RAM and data to be written from the special-purpose processing unit. To handle the general-purpose RAM read instruction, the general-purpose processing unit is preferably provide with a data path that obtains an address in the data RAM from the special-purpose processing unit and outputs the data at that address to the special-purpose processing unit. By providing these data paths, an architecture for the general-purpose processing unit that is an effective platform for a data processing apparatus of the present invention can be provided.

While a cooperative instruction is being executed, the general-purpose processing unit is used as part of the special-purpose processing unit, so that on obtaining a cooperative instruction or an instruction decoded from a cooperative instruction, it is preferable for the general-purpose processing unit to wait for the processing by the special-purpose processing unit to end and then output an indication to the fetch unit to fetch the next instruction code.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawings:

FIG. 1 is a block diagram showing the configuration of a data processing apparatus (processor) according to the present invention;

FIG. 2A shows the instruction format, and FIG. 2B shows the correspondence between GRP codes and categories;

FIG. 3 is a flowchart showing the processing of the FU;

FIGS. 4A and 4B show a program for a processor, with FIG. 4A showing a part that includes PU instructions and VU instructions and FIG. 4B showing a part that includes PU instructions and VU instructions that are cooperative instructions;

FIG. 5 shows the format of a V_OP instruction that is a general-purpose register access instruction;

FIG. 6 shows a data path used when executing the general-purpose register access instruction;

FIG. 7 is a timing chart for the execution of the general-purpose register access instruction;

FIG. 8 shows the format of a general-purpose computing unit access instruction V_PADD;

FIG. 9 shows a data path used when executing the general-purpose computing unit access instruction;

FIG. 10 shows the operations that can be designated by the general-purpose computing unit access instruction;

FIG. 11 shows the operations shown in FIG. 10 in more detail;

FIG. 12 is a timing chart for the execution of the general-purpose computing unit access instruction;

FIG. 13 is a different timing chart for the execution of the general-purpose computing unit access instruction;

FIG. 14 shows the format of a V_ST instruction that is a general-purpose RAM write instruction;

FIG. 15 shows the data path used when the general-purpose RAM write instruction is executed;

FIG. 16 shows the format of a V_LD instruction that is a general-purpose RAM read instruction; and

FIG. 17 shows the data path used when the general-purpose RAM read instruction is executed.

### DESCRIPTION OF THE PREFERRED EMBODIMENT

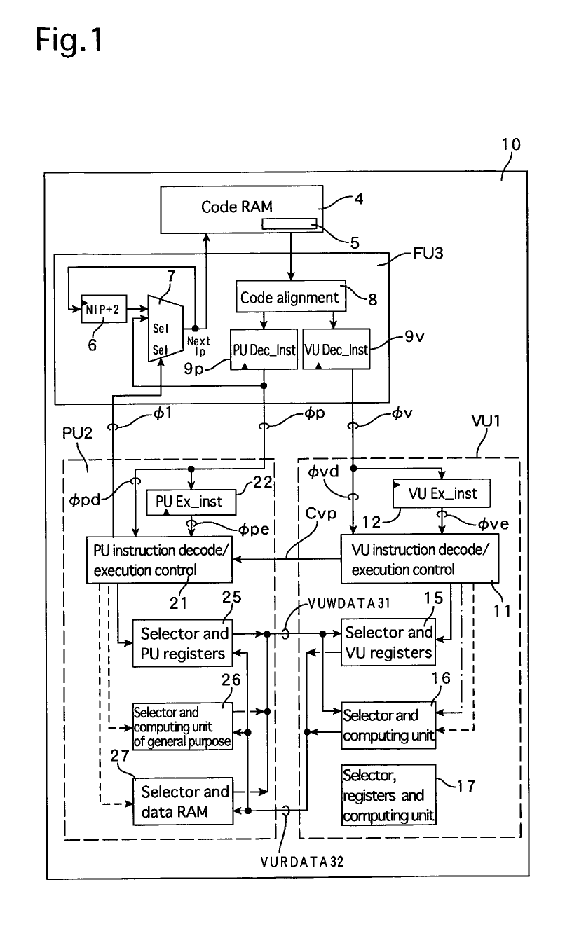

The following describes the present invention with reference to the attached drawings. FIG. 1 shows the configuration of a data processing system 10. The data processing system 10 is a system LSI (Large Scale Integrated Circuit) or a processor and includes a special-purpose processing unit 1 (a special-purpose data processing unit, hereafter referred to simply as a “VU”) that is dedicated to special-purpose processing and a general-purpose processing unit 2 (a general-purpose data processing unit or basic processing unit, hereafter “PU”) with a general-purpose configuration. The processor 10 is also equipped with a fetch unit (hereafter, “FU”) 3 that supplies decoded control signals or instructions to the VU 1 and the PU 2. The FU 3 fetches an instruction code (microcode) from executable program code (microprogram code, object cord or object program, also referred to as the “program”) 5 that is stored in a code RAM 4 and outputs the fetched instruction code as a decode stage instruction. The FU 3 is equipped with a register 6 for storing a starting address of the next instruction code, a selector 7 for selecting, in accordance with a control signal φ1 from the PU 2, the address in the register 6 or an address indicated by a decoded instruction φp and outputting the selected address to the code RAM 4 so that the next instruction code is fetched. In this way, the address of the next instruction code is fed back from the PU 2 and is inputted into the FU 3. The FU 3 is also equipped with a code alignment circuit 8 for aligning the fetched data, judging the type of the instruction code, and outputting the fetched data as a decode stage instruction. The code alignment circuit 8 also functions as a buffer and is also capable of prefetching instruction code when necessary.

The program 5 stored in the code RAM 4 includes special-purpose instructions (hereafter, “VU instructions”) that specify processing to be performed by the VU 1, general-purpose instructions (hereafter, “PU instructions”) that specify processing to be performed by the PU 2, and cooperative instructions that specify cooperative processing to be performed by both the VU 1 and the PU 2. The cooperative instructions are very effective in expanding the functions of the VU 1 in a processor 10 that is equipped with some VU 1 and a PU 2. In the present embodiment, cooperative instructions are incorporated into the instruction set of the VU instructions and are defined using the instruction format of VU instructions. The FU 3 has a function for decoding VU instructions and PU instructions and supplying the decoded results to the VU 1 and the PU 2. To do so, the FU 3 is equipped with a register 9v for storing, when the fetched instruction code is a VU instruction, a VU decode stage instruction (VU Dec_inst) φv in which the fetched instruction code is aligned and a register 9p for storing, when the fetched instruction code is a PU instruction, a PU decode stage instruction (PU Dec_inst) φp in which the fetched instruction code is aligned. If the fetched instruction code is a cooperative instruction, the instruction code is decoded, and an aligned VU decode stage instruction φv and a PU decode stage instruction φp are respectively stored in the register 9v and the register 9p.

The special-purpose processing unit VU 1 executes special-purpose instructions (VU instructions) that are user instructions, and is equipped with a decode/execution control circuit 11 that decodes the VU decode stage instruction φv and controls the processing in circuitry that is suited to the data processing specified by the VU decode stage instruction φv. As the dedicated circuitry, the VU 1 of the present embodiment is equipped with a first special-purpose circuit 15 that can access VU registers and includes selector logic for switching the input/output data path, and a second special-purpose circuit 16 that is equipped with a VU computing unit and includes selector logic, and by combining these two circuits is configured as a circuit that is suited to special-purpose computational processing. It is also possible to handle these two circuits to be a third special-purpose circuit 17 that is equipped with selector logic, VU registers, and a VU computing unit. In these dedicated circuits composed of the VU computing unit and the VU register, the processing is controlled and/or executed by hardware logic using a sequencer or hard-wired logic and the like for processing special-purpose data process dedicatedly. This means that while there is little flexibility, the special-purpose data process is executed at high speed.

It is possible to introduce pipeline processing into the VU 1. Such VU has a control cycle of the first special-purpose circuit 15 that can access the VU registers and a control or execution cycle of the second special-purpose circuit 16 that is equipped with the VU computing unit. The control cycle of the first special-purpose circuit 15 and the execution cycle of the second special-purpose circuit 16 proceed in stages (step by step). An execution stage instruction register 12 is provided for temporarily storing the VU decode stage instruction φv that has been supplied by the FU 3, with a VU execution instruction φve being outputted from this register 12. Hereafter, a VU decode stage instruction for performing register-related control is referred to as a VU register control instruction φvd. Also, the VU 1 of the present embodiment is assumed to be equipped with sixteen VU registers (numbered V₁₅ to V₀).

The general-purpose processing unit PU 2 is an execution unit for general-purpose instructions or basic instructions. In the present embodiment, the PU 2 is equipped with a decode/execution control circuit 21 for decoding a PU instruction φp and controlling circuitry that includes a general-purpose computing unit, such as an ALU (arithmetic logic unit). The circuitry that performs the general-purpose processing can be thought of as a combination of three general-purpose circuits 25 to 27. The first general-purpose circuit 25 is for accessing general-purpose registers (PU registers) and includes selector logic for switching the input/output data path. The second general-purpose circuit 26 is equipped with the general-purpose computing unit and includes selector logic and flag generating logic. The third general-purpose circuit 27 is for accessing a data RAM and includes selector logic.

Processing is executed in pipeline stages in the PU 2 and control cycles of the first general-purpose circuit 25 and the third general-purpose circuit 27 that access a register or the memory differ from an execution cycle of the second general-purpose circuit 26 that is equipped with the computing unit. An execution stage instruction register 22 is provided for temporarily storing the PU decode stage instruction φp that has been supplied by the FU 3, with a PU execution instruction φpe being outputted from this register 22. Hereafter, a PU decode stage instruction for performing register-related control is referred to as a PU register control instruction φpd. The PU 2 of the present embodiment is assumed to be equipped with sixteen PU registers (numbered P₁₅ to P₀).

Two data buses VURDATA 32 and VUWDATA 31 are provided for data transfers between the VU 1 and the PU 2. The VURDATA data bus 32 and the VUWDATA data bus 31 are both 32 bits (numbered 31 to 0) wide and can be accessed in 16-bit wide or units (bits 15 to 0 and bits 31 to 16). A VU/PU control signal Cvp is also provided between the VU 1 and the PU 2 for allowing the VU 1 and the PU 2 to control one another.

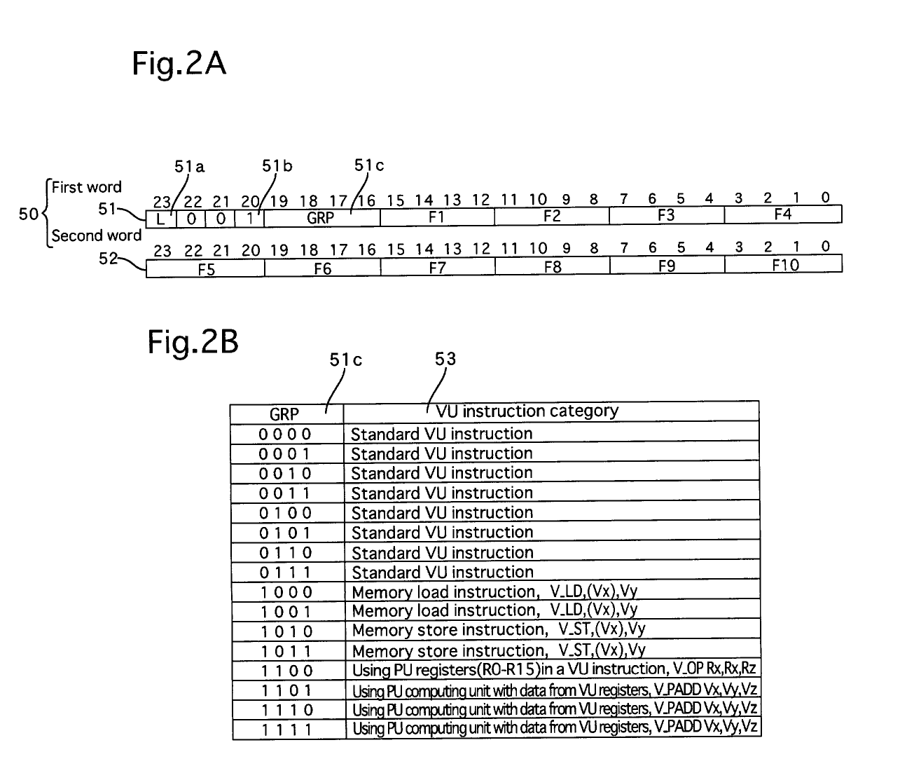

FIG. 2A shows the format of the instructions that compose the program 5. FIG. 2B shows the relationship between the “GRP” identifier in each instruction in the instruction set and the VU instruction category of the instruction. Each instruction 50 in the present program 5 is a variable-length instruction of up to two words in length, where each word is composed of 24 bits. The 23^{rd} bit L of the first word 51 is the data 51a that shows the instruction length. By decoding this data 51a, the instruction length can be determined. The 22^{nd} to 21^{st} bits of the first word are fixed at zero, and the data 51b of the following 20^{th} bit is a flag showing whether the instruction is a PU instruction or a VU instruction. The flag 51b is set at “0” in a PU instruction and at “1” in a VU instruction. In the present example, cooperative instructions are defined as being part of the set of VU instructions, so that the flag 51b is set at “1” in a cooperative instruction. It is also possible however to use a different flag to indicate a cooperative instruction.

The data GRP 51c in the 19^{th} to 16^{th} bits of the first word 51 shows the VU instruction category 53. When the data GRP 51c is set at “0000” to “0111”, this shows that the instruction is a user-defined VU instruction. When the data GRP 51c is set at “1000” to “1001”, this shows that the instruction is a cooperative instruction for accessing and reading data from the PU data RAM. When the data GRP 51c is set at “1010” to “1011”, this shows that the instruction is a cooperative instruction for accessing and writing data in the PU data RAM. When the data GRP 51c is set at “1100”, this shows that the instruction is a cooperative instruction for accessing the PU general-purpose registers. When the data GRP 51c is set at “1101” to “1111”, this shows that the instruction is a cooperative instruction for accessing the PU computing unit. In other words, when the data GRP 51c is set at “1000” to “1111”, this indicates that the instruction is a cooperative instruction. If the instruction is a cooperative instruction, the fields from the 15^{th} bit of the first word 51 onwards and every field in the second word 52 are divided into the ten 4-bit operand fields F1 to F10 to form spaces that are reserved for writing instruction opcodes and parameters of the VU instruction.

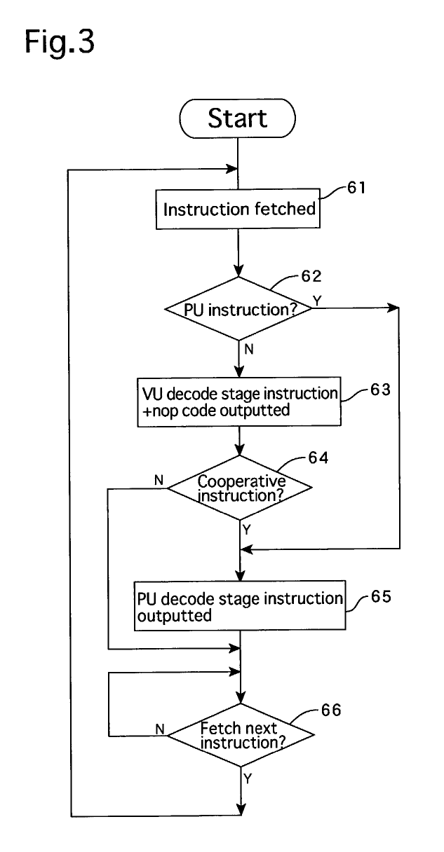

On fetching an instruction from the program 5, the FU 3 of the processor 10 performs the processing shown in FIG. 3. First, in step 61 the FU 3 outputs an address of the next instruction code to the code RAM 4 and fetches the instruction code 50. In step 62, if the fetched instruction code 50 is a PU instruction, the FU 3 outputs a PU decode stage instruction φp in step 65. On the other hand, if the instruction code 50 is a VU instruction, the FU 3 outputs a VU decode stage instruction φv and outputs a “nop” code as the PU decode stage instruction φp. By having a “nop” code supplied to the PU 2 instead of a VU decode stage instruction φv, the PU 2 does not perform processing but has the FU 3 fetch the next instruction code, so that processing can be performed in accordance with the next instruction code in the program 5. Also, if “nop” codes are supplied to the PU 2 instead of VU instructions, i.e., special-purpose instructions that may change depending on a user specification or the like, special-purpose instructions (VU instructions) that are user execution instructions can be freely defined without affecting the general-purpose nature of the PU 2.

It is determined in step 64 whether the VU instruction category 53 indicated by the GRP 51c of the fetched VU instruction is a cooperative instruction, and when this is the case, a PU decode stage instruction φp that is decoded from the VU instruction that is the cooperative instruction is outputted in step 65 instead of “nop”. When the fetched instruction code 50 is a VU instruction or a PU instruction, the address of the next instruction code is outputted in the next clock or cycle, and in step 61 the next instruction code is fetched. On the other hand, when the fetched instruction code 50 is a cooperative instruction, the resources of the PU 2 are used as part of the processing by the VU 1. Accordingly, in step 66, the FU 3 waits for the processing by the VU 1 to end and for the resources of the PU 2 to be made available before fetching the next instruction code. To do so, the VU/PU control signal Cvp is used.

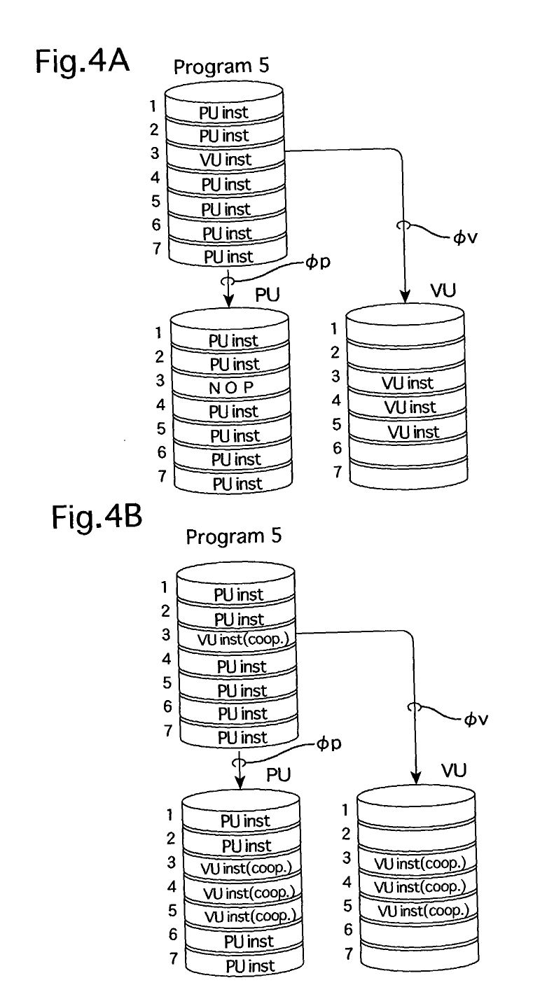

In more detail, as shown in FIG. 4A, if three clocks are required for the VU 1 to execute a VU instruction (shown as “V instructions” in the drawing) that is not a cooperative instruction, a “nop” code is supplied to the PU 2 when a VU instruction is fetched. After this, the next PU instruction (shown as “P instructions” in the drawing) is fetched in the next cycle. In this way, the processing by the VU 1 and the PU 2 proceeds in parallel.

On the other hand, when the VU instruction is a cooperative instruction as shown in FIG. 4B, a VU decode stage instruction φv is supplied to the VU 1 and a PU decode stage instruction φp that has been decoded from the VU instruction is supplied to the PU 2. If three clocks are required by the VU 1 to execute the VU instruction that performs the cooperative processing, the PU 2 is held up by the VU instruction for the same number of clocks. The processing of the PU 2 and the VU 1 is therefore synchronized.

In VUPU architecture having VU and PU applied in the processor or system LSI 10, VU instructions and PU instructions that compose the program 5 are fetched by the FU 3 in the order in which the instructions are arranged and are supplied to the VU 1 or the PU 2. The processing of the VU 1 and the PU 2 can be suitably controlled by a single program 5, and the processing of the VU 1 and the PU 2, including parallel processing, can be controlled at the program 5 level without providing a synchronization circuit or the like. The processing of the VU 1 and the PU 2 can be controlled in the cycles in which instruction codes are fetched, which is to say, in clock units. In a processor that has a plurality of VUs 1, parallel processing by the plurality of VUs 1 can also be controlled in clock units at the program level. When the VU 1 and the PU 2 need to be synchronized, this can also be performed at the program level by providing a synchronization instruction that waits for the end of a VU instruction.

By supplying a cooperative instruction to the VUPU architecture, the VU 1 and the PU 2 are synchronized and made or persuaded to perform the same processing. In the processor 10, by providing cooperative instructions at the program level and installing data paths such as the VUWDATA data bus 31 and the VURDATA data bus 32 that enable the resources of each of the VU 1 and the PU 2 to be used, it becomes possible to perform cooperative processing using new data paths that utilize some or all of the resources of both the VU 1 and the PU 2.

The program 5, which includes PU instructions, VU instructions and the cooperative instructions that have the instruction format of VU instructions, is provided having been stored on a recording medium, such as a code RAM or ROM, that is suited to storing a program for a processor. When there is a change in the user specification or a change at the development stage of the processor, the processing functions of the processor 10 can be freely changed by changing the program 5, making the system extremely flexible.

In the processor 10, four types of cooperative instructions are provided. The first cooperative instruction is a general-purpose register access instruction that has processing executed by the VU 1 with data in the general-purpose registers (PU registers) of the PU 2 as inputs. A description of this instruction is as shown below.

V_{—}OP Rx,Ry,Rz (1)

According to this VU instruction, the contents of the general-purpose registers Ry and Rz of the PU 2 are read, the computation indicated by the V_OP instruction is performed by the computing unit of the VU 1, and the result is stored in the general-purpose register Rx of the PU 2.

The second cooperative instruction is a general-purpose computing unit access instruction that has processing executed by the computing unit of the PU 2 with data in the special-purpose registers (VU registers) of the VU 1 as inputs. A description of this instruction is as shown below.

V_{—}PADD Vx,Vy,Vz (2)

According to this VU instruction, the contents of the special-purpose registers Vy and Vz of the VU 1 are read, computation is performed by the computing unit of the PU 2 and the result is stored in the special-purpose register Vx of the VU 1.

The third cooperative instruction is a general-purpose RAM write instruction that has data in a special-purpose register (VU register) of the VU 1 written in the data RAM of the PU 2, and is written as shown below.

V_{—}ST(Vx),Vy (3)

This VU instruction has the content of the VU register Vy stored in the data RAM of the PU 2 and the stored address of the data RAM is shown by the VU register Vx of the VU 1.

The fourth cooperative instruction is a general-purpose RAM read instruction that has data in the data RAM of the PU 2 written in a special-purpose register (VU register) of the VU 1, and is written as shown below.

V_{—}LD(Vx),Vy (4)

This VU instruction has the content of the address in the data RAM of the PU 2 that is indicated by the VU register Vx of the VU 1 stored in the VU register Vy of the VU 1.

These cooperative instructions are capable of appropriating some of the resources of the PU 2 for the processing of the VU 1, and so are capable of expanding the freedom of the processing of the VU 1, which is to say, the VU instructions that are the special-purpose instructions, without increasing the resources of the VU 1. By using such cooperative instructions, new data paths are constructed by the resources of the PU 2 and the resources of the VU 1 and processing is performed by using these data paths. As a result, processing that transfers data of the PU 2 to the VU 1 via a shared register or the like is totally unnecessary, and computation can be performed by the VU 1 using the data of the PU 2 and the result can be returned to the PU 2, all with a single instruction.

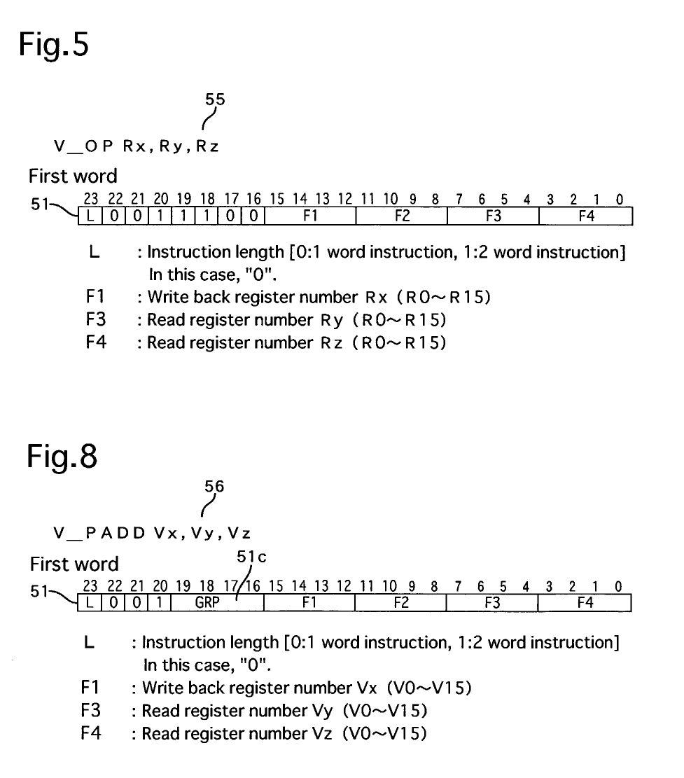

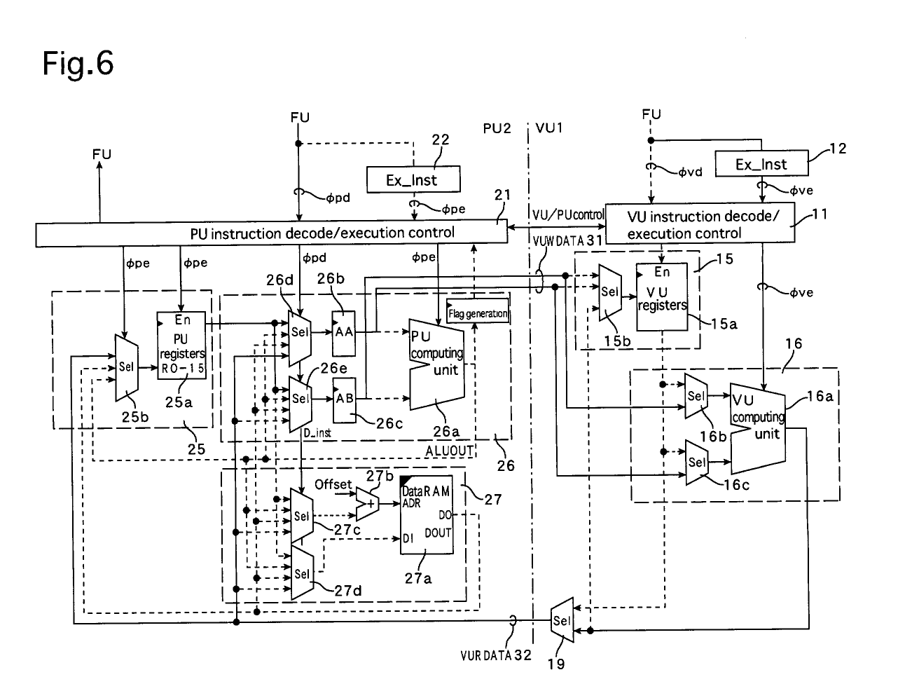

The following describes these cooperative instructions in more detail. FIG. 5 shows the instruction format of the general-purpose register access instruction V_OP, and FIG. 6 shows the data flow and control flow when this cooperative instruction is executed. The PU 2 has sixteen general-purpose registers (R₀ to R₁₅) in the present embodiment, so that a PU register can be indicated or designated using four bits. This means that the general-purpose register access instruction V_OP 55 is a single-word instruction code and can be written using the first word 51 of the instruction code 50.

In the PU 2, when the V_OP instruction 55 is outputted by the control signal φpd for the decode stage, a data path is formed so that the content of the Ry register in the PU registers is outputted to the 0 to 15^{th} bits of the VUWDATA data bus 31 and the content of the Rz register in the PU registers is outputted to the 16^{th} to 31^{st} bits of the VUWDATA data bus 31. The signal φpe for the execution and write back stages forms a data path so that the data on the 0 to 15^{th} bits of the VURDATA data bus 32 is written into the register Rx in the PU registers.

In the PU 2, as shown in FIG. 6, in the first general-purpose circuit 25, which includes the general-purpose registers (PU registers) 25a and the selector 25b, the selector 25b is set by the signal φpe so that the data on the VURDATA data bus 32 is written into the PU registers 25a. In the second general-purpose circuit 26, which includes the PU computing unit 26a, the input registers 26b and 26c, and the selectors 26d and 26e, the selector 26d and 26e are set by the signal φpd so that the data in the Ry register and the Rz register in the PU registers 25a is outputted to the VUWDATA data bus 31. Note that with this cooperative instruction 55, the write back stage needs to be performed in synchronization with the computation by the VU 1, so that during execution, the control signal φpe is outputted based on a VUWBEN signal (a write back control signal sent from the VU 1 to the PU 2) that is supplied by the VU 1 as the VU/PU control signal Cvp.

In the VU 1, in the second special-purpose circuit 16 that includes the VU computing unit 16a, the selectors 16b and 16c, the selectors 16b and 16c are set by the signal φve so as to select the VUWDATA data bus 31 as inputs. The VU computing unit 16a performs the user-defined computation, and the 16-bit result (and flag information as required) is outputted from the VURDATA data bus 32 via the selector 19. In this way, the general-purpose register access instruction V_OP 55 has a data path formed so that the VU computing unit 16a of the VU 1 performs computation with the general-purpose registers 25a of the PU 2 as inputs and the result is written back into the general-purpose registers 25a of the PU 2. In the VU 1, the computation designated by the general-purpose register access instruction V_OP 55 is executed.

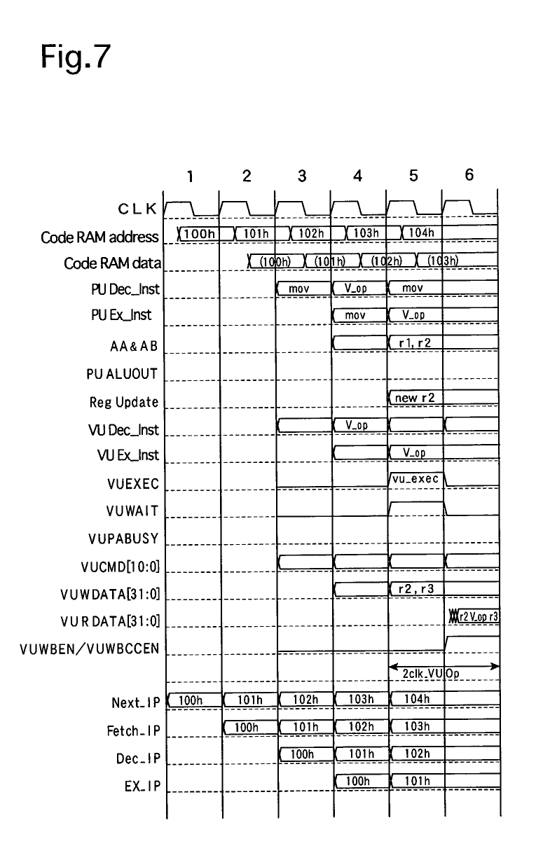

As shown by the timing chart in FIG. 7, three cycles are taken from the outputting of the general-purpose register access instruction V_OP 55 as the decode stage instruction (Dec_inst) in the fourth cycle until the computation result appears on the VURDATA data bus 32 and is written back into the general-purpose registers 25a of the PU 2. Therefore, only three clocks are consumed for V_OP operation. This means that no clocks are consumed by the transfer of data from the PU 2 to the VU 1, and that the data of the PU 2 can be used in computational processing by the VU 1 in only the time required for the computation by the VU 1.

The signals that are given in FIG. 7 and in the following timing charts are as shown below.

| CLK | Clock |
|---|---|
| Code RAM Address | Code RAM Address Input |
| Code RAM Data | Code RAM Data Output |
| PU Dec_Inst | PU Decode Stage Instruction |
| PU EX_Inst | PU Execution Stage Instruction |
| AA & AB | PU Computing Unit Input Data |
| PUALUOUT | PU Computing Unit Output Data |
| Reg Update | General-Purpose Register Data Value |
| | (Updated Value) |
| VU Dec_Inst | VU Decode Stage Instruction |
| VU EX_Inst | VU Execution Stage Instruction |
| VUEXEC | VU Execution Stage Timing Control Signal |
| VUWAIT | VU Instruction Completion Synch Control |
| | Signal When A VU Instruction is Executed |
| VUPABUSY | PU Computation Completion Synch Control |
| | Signal When the PU Computing Unit is in Use |
| VUCMD | Command Signal of a VU-I/F (PU Instruction) |
| VUWDATA | Write Data Bus from PU to VU |
| VURDATA | Write Data Bus from VU to PU |
| VUWBEN/VUWBCCEN | Flag Write Back Control Signal from VU to PU |
| Next_IP | Instruction Pointer to be Fetched Next |
| Fetch_IP | Instruction Pointer for the Fetch Stage |
| Dec_IP | Instruction Pointer for the Decode Stage |
| EX_IP | Instruction Pointer for the Execution Stage |

By using this kind of instruction 55, computation that is not implemented as standard in the PU 2 can be executed by the VU 1 directly accessing the registers of the PU 2 without creating overheads related to the transferring of data. This is extremely effective when a special kind of multiplication or shift instruction needs to be executed. As one example, even if the computation by the VU 1 is complex and so takes not one clock but a plurality of clocks, a read from the general-purpose registers 25a of the PU 2 and a write can be performed in a single clock, so that the processing that can be completed in only the number of clocks required by the computation by the VU 1. In other words, when the computation by the VU 1 takes a plurality of clocks, the execution stage of the PU 2 is stopped via a VU/PU control signal Cvp, for example, a VUWAIT signal that is a VU instruction completion synch control signal for when a VU instruction is executed. By putting the execution stage of the PU 2 into a wait state, the PU can be reliably made to operate in synchronization with the VU 1, so that the cooperative processing can be executed with no inconsistencies.

It is also possible for the selector 26d of the second general-purpose circuit 26 in the PU 2 to be set so that the computation result supplied from the VURDATA data bus 32 is returned to the VU 1, thereby forwarding the result to the computation of the VU 1.

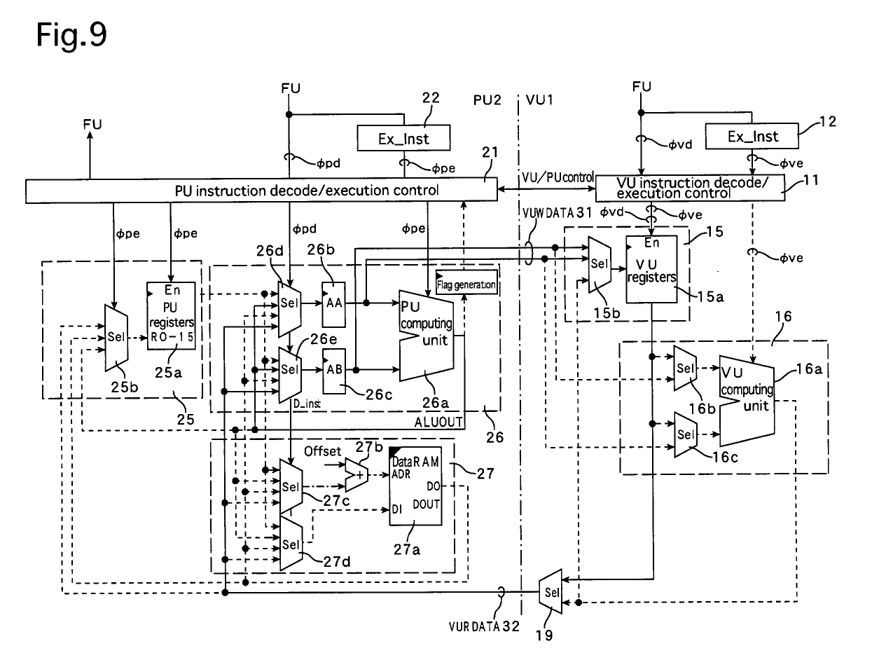

FIG. 8 shows the instruction format of a general-purpose computing unit access instruction V_PADD 56, and FIG. 9 shows the data flow and control flow when this cooperative instruction is executed. Since there are 16 (V₀ to V₁₅) VU registers 15a in the VU 1 in the present embodiment, a VU register can be indicated using four bits. Accordingly, a general-purpose computing unit access instruction V_PADD 56 is also a single-word instruction code and can be written in the first word 51 in the instruction code 50.

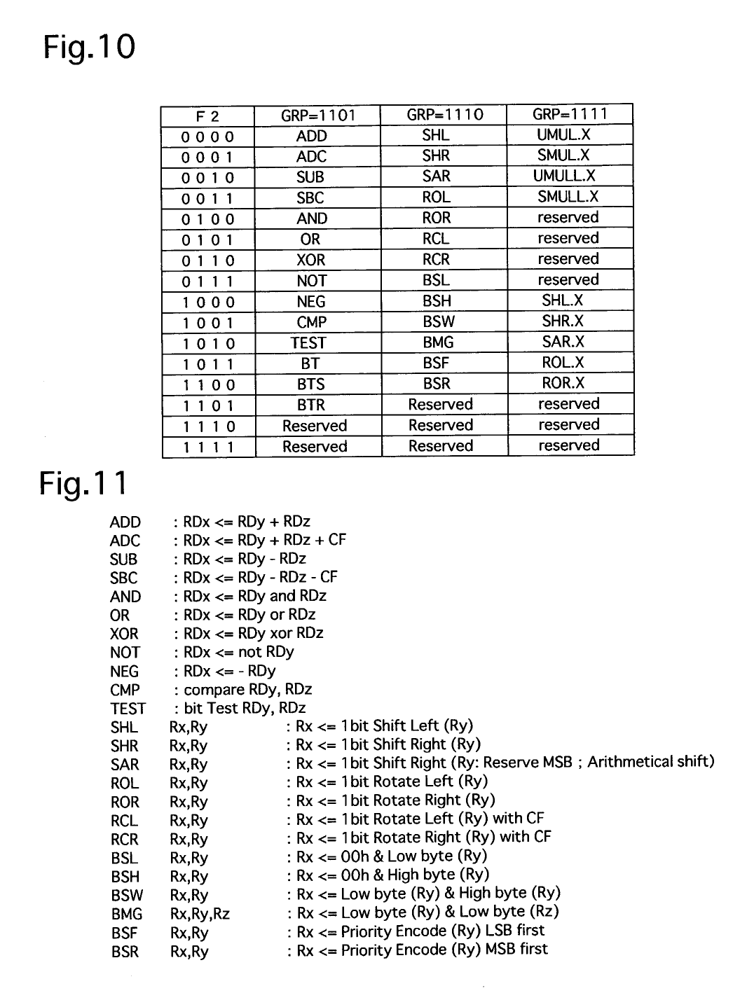

The PU 2 is a basic instruction execution unit, and is a predefined unit for providing preset functions that are unrelated to the functions of the VU 1. This means that even if the user can indicate or designate the computational processing performed by the PU 2, the user cannot define or rearrange such processing for VU processing. In the present embodiment, as shown in FIG. 10, by using the codes written in the GRP code 51c and the F2 operand field, a predefined computational function executed by the PU 2 is indicated by the V_PADD instruction 56 that is a VU instruction for VU processing.

The various processes shown in FIG. 10 are as shown in FIG. 11. A computational function using the general-purpose registers is shown, but by using a V_PADD instruction 56, the various computations can be executed with the VU registers 15a being indicated in place of the general-purpose registers. It should be noted that “CF” in FIG. 11 represents a condition code.

In the second general-purpose circuit 26 of the PU 2, when the V_PADD instruction 56 is outputted as a decode stage instruction φpd, a data path is formed so that the data on the oth to 15^{th} bits of the VURDATA data bus 32 and the data on the 16^{th} to 31^{st} bits of the VURDATA data bus 32 that are outputted from the VU 1 are respectively assigned to the input ports A and B of the computing unit 26a of the PU 2 and computation designated by the V_PADD instruction 56 that is one of the VU instructions is executed by the computing unit 26a of the PU 2. A data path whereby the output of the computing unit 26a is supplied to the VU 1 via the VUWDATA data bus 31 is also formed.

As shown in FIG. 9, in the second general-purpose circuit 26 that includes the PU computing unit 26a of the PU 2, the selectors 26d and 26e are set by the decoded stage signal φpd so as to select the data from the VURDATA data bus 32 as inputs. The computing unit 26a, that is ALU in this case, is set so as to execute the computation indicated by the GRP code 51c and the code F2 in the V_PADD instruction 56 and when the computation result has been outputted, the selector 26d is switched and set so as to output the computation result via the register 26b to the 0th to 15^{th} bits of the VUWDATA data bus 31. Also, when a flag changing indication from the VU 1 has been given via the VU/PU control signal Cvp, a flag for the computation result is stored in the flag register.

In the first special-purpose circuit 15 that includes the VU registers 15a and the selector 15b, the VU registers 15a and the selector 19 are set by the decode stage signal φvd so that the data of the two registers selected out of the VU registers 15a is transferred to the PU 2 via the oth to 31^{st} bits of the VURDATA bus 32. The selector 15b is set by the execution signal φve during execution so as to write the data on the 0th to 15^{th} bits of the VUWDATA bus 31 into a register selected out of the VU registers 15a. Note that in the case where there are a plurality of VUs 1, when a VU instruction is decoded, in the suitable VU 1 (which is to say, the VU 1 that is to execute the V_PADD 56 instruction) there are cases where a forwarding mechanism for the VU registers 15a or a mechanism for adjusting the timing using “nop” codes is required.

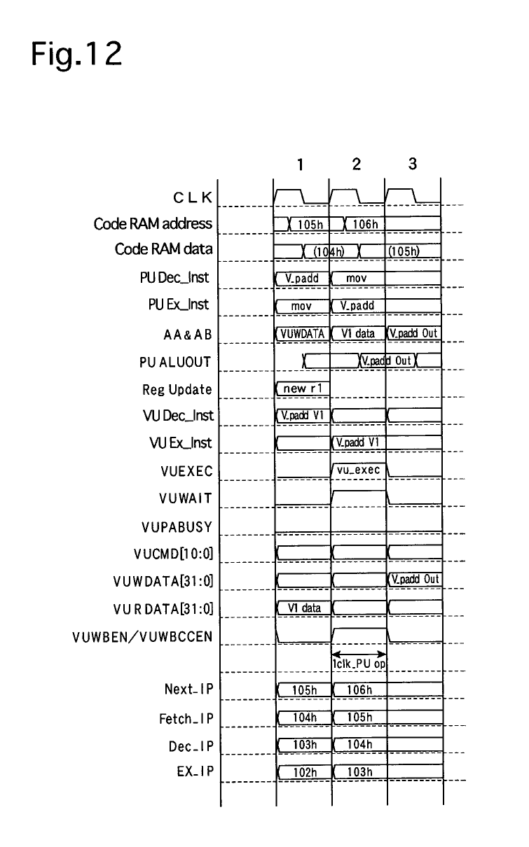

In the processor 10 of the present embodiment, the general-purpose computing unit access instruction V_PADD 56 has or persuades a data path formed so that computation is performed by the PU computing unit 26a of the PU 2 with the VU registers 15a of the VU 1 as inputs, and the result of this computation is written back into the VU registers 15a of the VU 1. Then the computation indicated by the general-purpose computing unit access instruction V_PADD 56 is executed by the computing unit 26a in the PU 2. As shown by the timing chart in FIG. 12, three cycles are taken from the output of the general-purpose computing unit access instruction V_PADD 56 as a decode stage instruction (Dec_inst) in the first cycle until the computation result of the PU 2 appears on the VUWDATA bus 31 and this result is written back into the VU registers 15a of the VU 1, which is to say, three clocks are consumed by this processing. This means that no clocks are consumed by the transferring of data from the VU 1 to the PU 2, and that the computational functions of the PU 2 can be used by the VU 1 in only the time required by the computational processing by the PU 2.

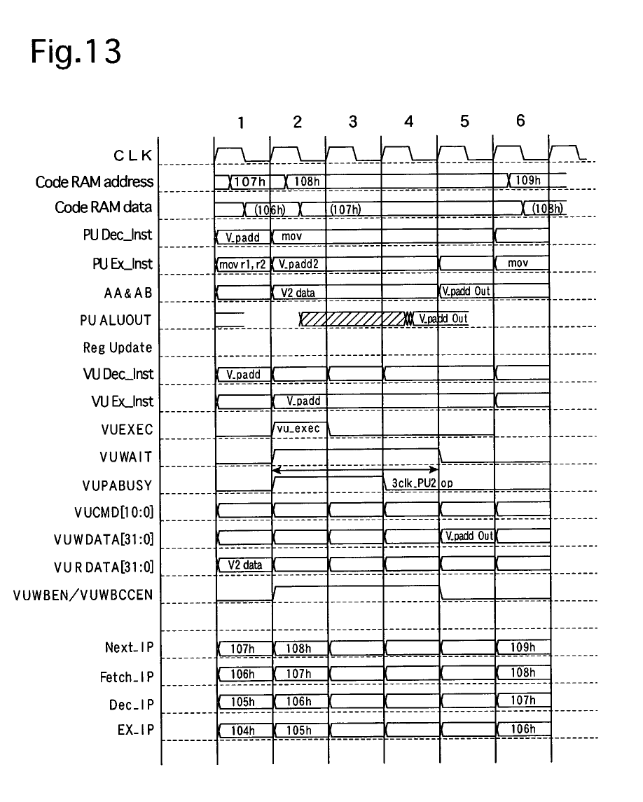

The timing chart in FIG. 13 shows the case when a V_PADD instruction 56 whose execution consumes three cycles (clocks) is executed, and corresponds to the case shown in FIG. 4B. When the VU instruction for this cooperative processing is fetched, in the first cycle the general-purpose computing unit access instruction V_PADD 56 is outputted as a decode stage instruction (Dec_inst), in the second to fourth cycles, processing is performed using the PU computing unit 26a, and in the fifth cycle the result of this processing appears on the VUWDATA bus 31 (V_PADD OUT). The result is also written into the VU registers 15a of the VU 1 in this fifth cycle. Accordingly, five cycles are taken to execute the general-purpose computing unit access instruction V_PADD 56 that is executed using three clocks, or in other words, only five clocks are consumed, meaning that data in the VU 1 can be processed by the computing unit 26a of the PU 2 without using any more clocks than when an instruction whose execution consumes three clocks is executed in the PU 2 or the VU 1 in which the necessary data is already present.

In this way, with the processor 10 of the present embodiment, by using a general-purpose computing unit access instruction V_PADD 56, the computational functions of the PU 2 can be used by the VU 1 in only the time required by the computation in the PU 2 and without any clocks being consumed by the transfer of data from the VU 1 to the PU 2. A reduction is made in the time taken by computational processing that uses the PU 2 and the processing speed is increased. By this instruction that is a symmetrical form to the V_OP instruction described above, the functions of the PU computing unit do not need to be duplicated within the processor 10 if such computations are required as VU operation. In addition, the computing unit of the PU can be accessed and used with the registers in the VU 1 without time loss. This means that if the user specification that is implemented as the VU 1 includes computation that can be processed using the PU 2 and there is no need for the VU 1 to perform data processing in parallel with the PU 2, or if the ability for the VU 1 and the PU 2 to execute parallel processing is abandoned, the VU 1 does not need to be equipped with a computing unit and data path for executing such computation and so can be made more compact. Accordingly, it is possible to reduce the development and the number of design processes of a VU 1 for implementing user logic, and to reduce the number of test processes, so that a processor that is equipped with a VU 1 can be provided more economically.

Also, as described above, an environment is provided in which the computing unit 26a of the PU 2 can be used by the VU 1 without loss of time, so that it becomes possible for the VU 1 to make use of the various computational abilities of the PU computing unit 26a shown in FIG. 10. A large increase is made in the freedom of the user logic implemented as the VU 1, which is to say, the special-purpose instructions. Such freely designable special-purpose instructions (VU instructions) can also be executed at high speed without consuming clocks for data transfers. Accordingly, a compact processor or system LSI with (i) great flexibility for handling a specification demanded by a user or an application, and (ii) a high execution speed that is suited to real-time processing, can be provided at low cost.

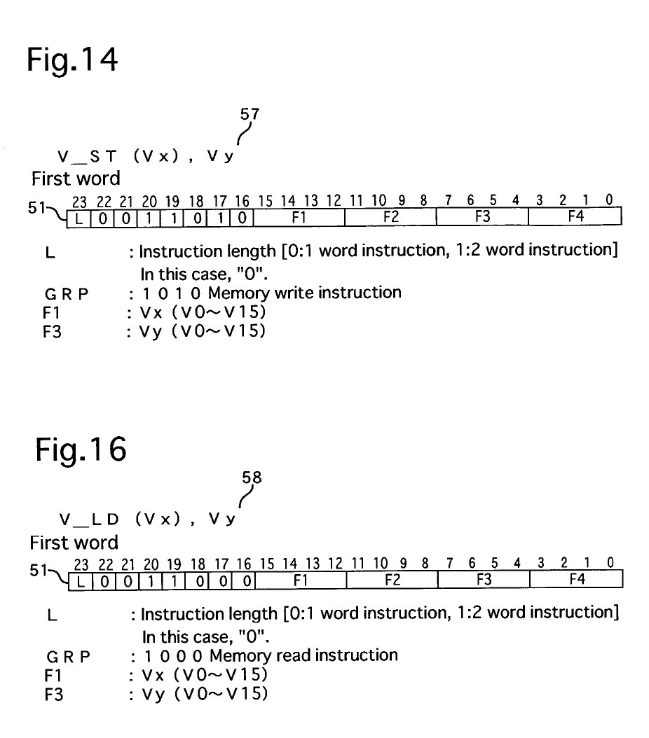

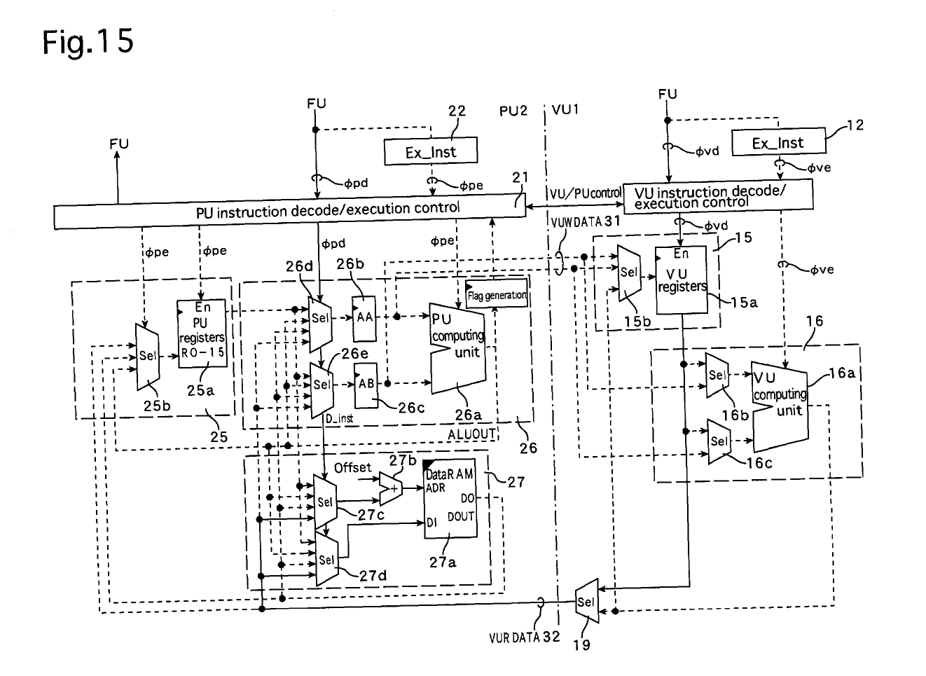

FIG. 14 shows the instruction format of a general-purpose RAM write instruction (memory store instruction) V_ST 57. FIG. 15 shows the data flow and control flow when this cooperative instruction is executed. Since there are 16 (V₀ to V₁₅) VU registers 15a in the VU 1, a VU register can be indicated or identified using four bits. Accordingly, a general-purpose RAM write instruction V_ST 57 is also a single-word instruction code and can be described in the first word 51 in the instruction code 50.

In the PU 2, when the V_ST instruction 57 is outputted as the decode stage instruction φpd, a data path is formed so that the data on the 0^{th} to 15^{th} bits of the VURDATA data bus 32 that is outputted from the VU 1 is set up as an address in the data RAM 27a of the PU 2 and the data on the 16^{th} to 31^{st} bits of the VURDATA data bus 32 is set up as write data for the data RAM 27a.

As shown in FIG. 15, in the third general-purpose circuit 27 that includes the data RAM 27a, the adder 27b for adding an offset for an address, a selector 27c for selecting an address input, and a selector 27d for selecting a data input, the selectors 27c and 27d are set by the decode stage signal φpd so as to select data on the VURDATA data bus 32 as inputs. When a memory write indication has been given via a VU/PU control signal Cvp sent from the VU 1, the memory write cycle is executed and data is written in the data RAM 27a.

In the VU 1, the VU registers 15a and the selector 19 are set by the decode stage signal φvd so as to transfer the data in two registers selected out of the VU registers 15a to the PU 2 via the 0^{th} to 31^{st} bits of the VURDATA data bus 32. Note that in the case where there are a plurality of VUs 1, when a VU instruction is decoded, in the suitable VU 1, which is to say, the VU 1 that is to execute the VU instruction, there are cases where a forwarding mechanism for the VU registers 15a or a mechanism for adjusting the timing using “nop” codes is required.

By using a general-purpose RAM write instruction V_ST 57, data present in the VU 1 can be written in the data RAM 27a of the PU 2 without transferring data using the PU general-purpose registers 25a. Compared to a method where data in the VU 1 is stored via the general-purpose registers of the PU 2, there is the significant effect that data can be stored in a single cycle, which is to say, in a single clock, so that the number of clocks consumed by this processing are decreased. While the processing by the VU 1 according to the V_ST cooperative instruction 57 holds up the processing of the PU 2, processing that transmits data via the general-purpose registers 25a is omitted from the PU 2, so that the processing efficiency of the PU 2 is increased.

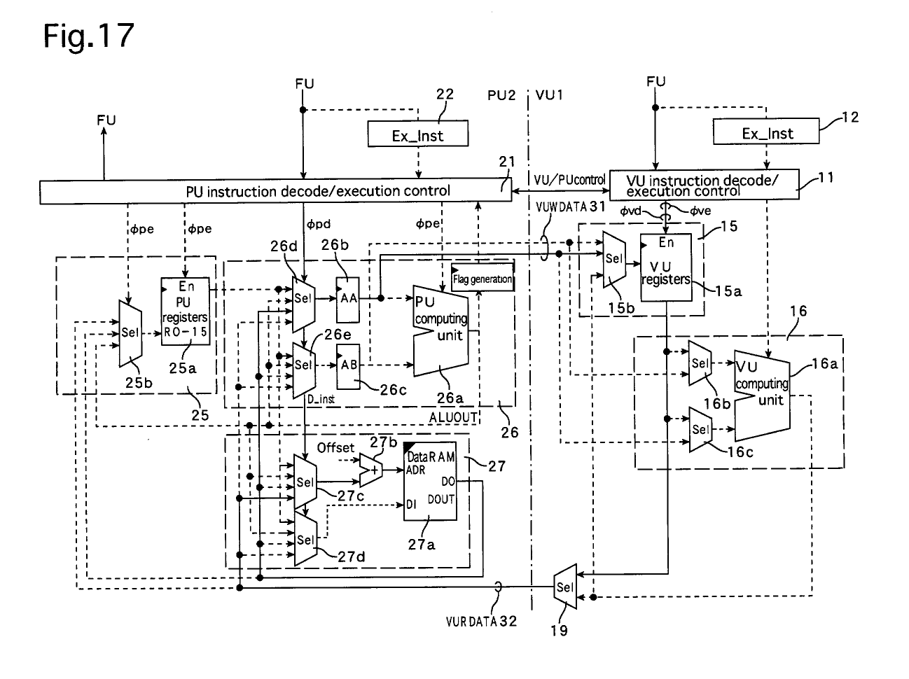

FIG. 16 shows the instruction format of a general-purpose RAM read instruction (memory load instruction) V_LD 58. FIG. 17 shows the data flow and control flow when this cooperative instruction is executed. Since there are 16 (V₀ to V₁₅) VU registers 15a in the VU 1, a VU register can be indicated using four bits. Accordingly, a general-purpose RAM read instruction (memory load instruction) V_LD 58 is also a single-word instruction code and can be written in the first word 51 in the instruction code 50.

In the PU 2, once the V_LD 58 instruction has been outputted as a decode stage signal φpd, a data path is formed so that the data on the 0^{th} to 15^{th} bits of the VURDATA data bus 32 that is outputted from the VU 1 is set up as a read or load address of the data RAM 27a of the PU 2 and the output of the data RAM 27a is set up to output to the oth to 15^{th} bits of the VUWDATA data bus 31.

As shown in FIG. 17, in the third general-purpose circuit 27, according to the decode stage signal φpd, the selector 27c is set so as to select data on the VURDATA data bus 32 as an input and the selector 26d is set so that the output of the data RAM 27a is outputted via the registers 26b to the VUWDATA data bus 31. When a memory read indication has been given by the VU 1 via a VU/PU control signal Cvp, the memory read cycle is executed and the read data is latched by the registers 26b and outputted to the VUWDATA data bus 31.

In the VU 1, the VU registers 15a and the selector 19 are set by the decode stage signal φvd so as to transfer the data in one register selected out of the VU registers 15a to the PU 2 via the 0^{th} to 15^{th} bits of the VURDATA data bus 32. The execution stage of the V_LD instruction 58 has a two-clock composition, and in the second clock, the output of the PU 2 (data that is outputted by the registers 26b and supplied by the VUWDATA data bus 31) is written or stored into the indicated register in the VU registers 15a. Note that in cases where there are a plurality of VUs 1, when this VU instruction is decoded, in the suitable VU 1, which is to say, the VU 1 that is to execute this VU instruction, there are also cases where a forwarding mechanism for the VU registers 15a or a mechanism for adjusting the timing using “nop” codes is required.

This general-purpose RAM read instruction V_LD 58 is an instruction with a symmetrical form to the general-purpose RAM write instruction V_ST 57 described above, and in the same way, can write or store data that is present in the data RAM 27a of the PU 2 into registers of the VU 1 without transferring data using the general-purpose registers 25a. Compared to a method where data is stored in the VU 1 via the general-purpose registers of the PU 2, data can be stored in the VU registers 15a in one cycle, which is to say, in one clock, so that the number of clocks consumed by this processing are reduced. In the same way as above, this cooperative control-type VU instruction is extremely effective.

The general-purpose register access instruction V_OP 55, the general-purpose computing unit access instruction V_PADD 56, the general-purpose RAM write or store instruction V_ST 57, and the general-purpose RAM read or load instruction V_LD 58 are cooperative instructions that are implemented as part of the set of VU instructions, and by making some of the resources of the PU 2 available to the VU 1 enable the resources of the PU 2 to be incorporated into a data path that executes processing in the VU 1. By these cooperative instruction, data transfers are performed between the VU 1 and the PU 2 without MOVE instructions. Therefore, computation that is performed using the computing unit of the VU 1, computation that is performed using the computing unit of the PU 2, and accesses to the data RAM of the PU 2 are performed without wasting clocks. As a result, a large improvement can be made in the processing efficiency of the processor (VUPU processor) 10 that has PU 2 equipped with general-purpose functions as a platform, and one or more VUs 1 for implementing user logic. This effect of the invention is especially prevalent in cases where there are short time required user instructions (VU instructions) for which processing by a VU 1 is completed in a few clocks and so many data transfer processes would be frequently performed if the present invention were not used.

With the present embodiment, to achieve the above effect it is necessary for users to use cooperative instructions in accordance with the specified format of VU instructions. In the present embodiment, the 4-bit GRP code 51c is specified in the instruction format 50 and reserves the four bits in the instruction format that extends an operand field with a total length of 48 bits for the GRP code 51c of the cooperative instruction. However, such extension is permissible due to the significant gain in processing speed that is achieved through the use of cooperative instructions. While cooperative instructions are introduced, this does not mean that other user-defined standard instructions for purposes such as transferring data cannot be defined, so that MOVE instructions and the like for transferring data between the general-purpose registers 25a of the PU 2 and the VU registers 15a of the VU 1 can also be used.

In order to implement cooperative instructions that make the resources of the PU 2 available, with regard to V_OP 55 instructions, the PU 2 may be provided with data paths that have the contents of specified register or registers in the general-purpose registers 25a outputted to the VUWDATA data bus 31 and data on the VURDATA data bus 32 written into a specified register in the general-purpose registers 25a. The data paths are not limited to the construction described above, but by providing (i) a data path that outputs data in general-purpose registers 25a that are specified by a general-purpose register access instruction V_OP 55 to the VU 1, and (ii) a data path that writes data which has been processed by the VU 1 into a general-purpose register 25a specified by a general-purpose register access instruction V_OP 55, as standard data paths of the PU 2, the PU 2 can be made to function as a platform for a processor 10 that is equipped with a VU 1 capable of executing the general-purpose register access instruction V_OP 55 as one of VU instructions. By using this configuration, cooperative instructions can be implemented without sacrificing the general-purpose nature of the PU 2.

In the same way, (i) a data path that assigns the data on the VURDATA data bus 32 that is outputted from the VU 1 to inputs of the computing unit 26a of the PU 2 so that the data can be used in computation executed by the computing unit 26a, and (ii) a data path that supplies the output of the computing unit 26a via the VUWDATA data bus 31 to the VU 1, are formed for a V_PADD instruction 56. In other words, by providing the PU 2 with a data path that has processing indicated by the instruction 56 performed in the PU computing unit on data supplied from the VU 1 and the result of this processing outputted to the VU 1, the PU 2 can be made into a suitable platform for implementing a general-purpose computing unit access instruction V_PADD 56.

A data path that sets up data on the VURDATA data bus 32 that is outputted by the VU 1 as an address and store data in the data RAM 27a of the PU 2 is provided for a V_ST instruction 57. In other words, by providing the PU 2 with a data path that obtains an address and data for write in RAM from the VU 1, a PU that can perform the general-purpose RAM write instruction V_ST 57 can be provided. Also, by forming a data path that has data on the VURDATA data bus 32 that is outputted from the VU 1 set up as an address in the data RAM 27a of the PU 2 and has the output of the data RAM 27a outputted to the VUWDATA data bus 31, which is to say, by providing a PU 2 with a data path that obtains an address in the data RAM from the VU 1 and outputs data at that address in the data RAM to the VU 1, a PU 2 that can perform the general-purpose RAM read instruction V_LD 58 can be provided.

It should be noted that the types of cooperative instructions are not limited to the instructions that are described in this embodiment. However, the above cooperative instructions are some of effective cooperative instruction for providing a PU 2 that becomes tighter coupling with VU for realizing a user instruction, with each unit being able to access the other's resources. As described above, parallel processing by the VU and the PU cannot be performed while such accesses are being made, though programming that prioritizes parallel processing is still possible. This means that by implementing the cooperative instructions of the present invention, processors that offer greater flexibility and faster processing can be provided.

As described above, the present VUPU processor includes a VU that is implemented in accordance with a user specification by converting processes that need to be executed at high speed into special-purpose circuits, and a PU that supports general-purpose functions, such as error handling. The VUPU processor is flexible enough to handle changes in a specification or the like according to a program. As a result, the processor offers both a programmable flexibility and high-speed processing through the use of special-purpose circuits. Users can design the VU themselves, making the processor a semi-customizable processor where user instructions can be implemented as VU instructions with a high degree of freedom. This means that high-performance system LSIs can be developed and manufactured as application-specific processors in an extremely short time and at low cost.

With the present invention, cooperative instructions that specify cooperative processing for the VU and PU are introduced. These cooperative instructions make the resources of the PU available to the VU, so that the overheads that are required for the transfer of data between the VU and the PU can be effectively removed and the processing time taken when the VU is used can be further reduced, thereby making it possible to provide a processor that is even more suited to applications, such as image processing and network processing, that need to respond in real-time. In addition, by making the resources of the PU available to the VU, it becomes possible for the functions of the PU to be used as VU instructions, which is to say, as part of the user instructions, so that VU instructions can be implemented with even greater freedom without increasing the resources of the VU. The data processing apparatus of the present invention can provide a processor or a system LSI that can achieve both a high degree of flexibility and high processing speed, and by using the present invention, a data processing apparatus that is even more suited to high-speed network and image processing applications can be provided.

What is claimed is:

1. A data processing system, comprising:
a special-purpose processing unit that includes dedicated circuit that is suited to special data processing;
a general-purpose processing unit that is suited to general-purpose data processing; and
a fetch unit for supplying when an instruction fetched from a code memory is a special-purpose instruction that specifies processing to be performed by the special-purpose processing unit, one of the special-purpose instruction and an instruction produced by decoding the special-purpose instruction to the special-purpose processing unit, for supplying when the fetched instruction is a general-purpose instruction that specifies processing to be performed by the general-purpose processing unit, one of the general-purpose instruction and an instruction produced by decoding the general-purpose instruction to the general-purpose processing unit, and for supplying, when the fetched instruction is a cooperative instruction that specifies cooperative processing by the special-purpose processing unit and the general-purpose processing unit, one of the cooperative instruction and an instruction produced by decoding the cooperative instruction to the special-purpose processing unit and the general-purpose processing unit.

2. A data processing system according to claim 1,
wherein the cooperative instruction is an instruction that makes at least some hardware resources of the general-purpose processing unit available to the special-purpose processing unit.

3. A data processing system according to claim 1,
wherein the cooperative instruction is a general-purpose register access instruction for executing processing in the special-purpose processing unit with data in general-purpose registers in the general-purpose processing unit as input, and
the general-purpose processing unit includes a data path for outputting data in the general-purpose registers designated by the general-purpose register access instruction and a data path for writing data that has been processed in the special-purpose processing unit into the general-purpose register designated by the general-purpose register access instruction.

4. A data processing system according to claim 1,
wherein the cooperative instruction is a general-purpose computing unit access instruction for executing processing in a computing unit of the general-purpose processing unit with data in special-purpose registers in the special-purpose processing unit as input, and
the general-purpose processing unit includes a data path for supplying data from the special-purpose data processing unit for performing the processing designated by the general-purpose computing unit access instruction in the computing unit and outputting a result to the special-purpose processing unit.

5. A data processing system according to claim 1,
wherein the cooperative instruction is a general-purpose RAM write instruction for writing data present in special-purpose registers in the special-purpose processing unit into a data RAM of the general-purpose processing unit, and
the general-purpose processing unit includes a data path for obtaining, from the special-purpose processing unit, an address in the data RAM and data to be written.

6. A data processing system according to claim 1,
wherein the cooperative instruction is a general-purpose RAM read instruction for writing data present in a data RAM of the general-purpose processing unit into special-purpose registers in the special-purpose processing unit, and
the general-purpose processing unit includes a data path for obtaining an address in the data RAM from the special-purpose processing unit and outputting data present at the address to the special-purpose processing unit.

7. A data processing system according to claim 1,
wherein the general-purpose processing unit, on obtaining the cooperative instruction or the instruction that has been decoded from the cooperative instruction, waits for processing in the special-purpose processing unit to end and outputs an indication to fetch the next instruction code to the fetch unit.

8. A data processing system according to claim 1, comprising a plurality of special-purpose processing units.

9. A program product for a data processing system including a special-purpose processing unit that includes dedicated circuitry that is suited to special data processing and a general-purpose processing unit that is suited to general-purpose data processing, comprising:
a special-purpose instruction for specifying processing to be performed by the special-purpose processing unit;
a general-purpose instruction for specifying processing to be performed by the general-purpose processing unit; and
a cooperative instruction for specifying processing to be performed by the special-purpose processing unit and the general-purpose processing unit.

10. A program product according to claim 9,
wherein the special-purpose instruction, the general-purpose instruction, and the cooperative instruction are fetched in a sequence in which the special-purpose instruction, the general-purpose instruction, and the cooperative instruction are arranged.

11. A program product according to claim 9,
wherein the cooperative instruction is an instruction that makes at least some hardware resources of the general-purpose processing unit available to the special-purpose processing unit.

12. A program product according to claim 9,
wherein the cooperative instruction is any of:
a general-purpose register access instruction that persuades the special-purpose processing unit execute processing with data in general-purpose register of the general-purpose processing unit as input;
a general-purpose computing unit access instruction that persuades a computing unit of the general-purpose processing unit execute processing with data in special-purpose register of the special-purpose processing unit as input;
a general-purpose RAM write instruction for writing data present in special-purpose register of the special-purpose processing unit into a data RAM of the general-purpose processing unit; and
a general-purpose RAM read instruction for writing data present in a data RAM of the general-purpose processing unit into special-purpose register of the special-purpose processing unit.

13. A method of controlling a data processing system, comprising steps of:
fetching an instruction code from a code memory;
supplying, when the fetched instruction code is a special-purpose instruction that specifies processing to be performed by a special-purpose processing unit that includes dedicated circuitry that is suited to special data processing, one of the special-purpose instruction and an instruction decoded from the special-purpose instruction to the special-purpose processing unit;
supplying, when the fetched instruction code is a general-purpose instruction that specifies processing to be performed by a general-purpose processing unit that is suited to general-purpose data processing, one of the general-purpose instruction and an instruction decoded from the general-purpose instruction to the general-purpose processing unit; and
supplying, when the fetched instruction is a cooperative instruction that specifies cooperative processing to be performed by both the special-purpose processing unit and the general-purpose processing unit, one of the cooperative instruction and an instruction decoded from the cooperative instruction to the special-purpose processing unit and the general-purpose processing unit.

14. A method according to claim 13,
wherein the cooperative instruction is an instruction that makes at least some hardware resources of the general-purpose processing unit available to the special-purpose processing unit.

15. A method according to claim 13,
wherein the cooperative instruction is any of:
a general-purpose register access instruction that persuades the special-purpose processing unit execute processing with data in general-purpose registers of the general-purpose processing unit as input;
a general-purpose computing unit access instruction that persuades a computing unit of the general-purpose processing unit execute processing with data in special-purpose registers of the special-purpose processing unit as input;
a general-purpose RAM write instruction for writing data present in special-purpose registers of the special-purpose processing unit into a data RAM of the general-purpose processing unit; and
a general-purpose RAM read instruction for writing data present in a data RAM of the general-purpose processing unit into special-purpose registers of the special-purpose processing unit.

16. A method according to claim 13,
further comprising a step of waiting, when the cooperative instruction has been fetched, until processing by the special-purpose processing unit has ended and then fetching a next instruction code.
